(19) United States
(12) Patent Application Publication
(10) Pub. No.: US 2012/0318841 A1
(43) Pub. Date: Dec. 20, 2012

(54) PNEUMATIC NAILING MACHINE WITH AN EXHAUST CONTROL DEVICE

(76) Inventors: Angi LIU, Taichung (TW); Fu-Ying HUANG, Taichung (TW)

(21) Appl. No.: 13/361,062

(22) Filed: Jan. 30, 2012

(30) Foreign Application Priority Data
Jun. 20, 2011 (TW) 100211124

(51) Int. Cl. B25C 1/04

(52) U.S. Cl. 227/130

(57) ABSTRACT

A pneumatic nailing machine includes a piston and driver assembly movably disposed in a striking cylinder for driving a fastener out of a front end of a main housing when primary pressured air is supplied to the cylinder, a head valve forced open when an active pressure generated as a result of flow of the primary pressured air is higher than a counter pressure in a counter-pressure zone, and an air valve unit convertible, in response to a throttling action applied to supply of secondary pressured air into the counter pressure zone, between a led-through state, where the head valve is kept unmoved in a closed position, and a shut-off state, where the flow of the secondary pressured air is disrupted thereby forcing the head valve forced open.

### CROSS-REFERENCE TO RELATED APPLICATION

This application claims priority of Taiwanese Patent Application No. 100211124, filed on Jun. 20, 2011, the disclosure of which is herein incorporated by reference.

### BACKGROUND OF THE INVENTION

1. Field of the Invention

This invention relates to a pneumatic nailing machine, more particularly to a pneumatic nailing machine with an exhaust control device.

2. Description of the Related Art

Referring to FIG. 1, an exhaust mechanism of conventional pneumatic nailing machine 1 disclosed in U.S. Pat. No. 5,878,936 includes a striking cylinder 12 accommodated in a main housing 11, and a piston and driver assembly 19 disposed in the striking cylinder 12 and driven to drive a nail when compressed air is supplied to the striking cylinder 12 from an access opening 121. When a trigger is pulled to move a start valve 14 to open a passage 15, compressed air in a head valve chamber 18 is exhausted through an exhaust port 16 so that a head valve 13 is opened, and compressed air in a compressed air chamber 17 bursts into the striking cylinder 12 to drive the piston and driver assembly 19 for striking a nail. After the nail has been driven, the trigger is returned to its original position to move the start valve 14 so as to open the compressed air chamber 17 to the passage 15, thereby permitting flow of the compressed air into the head valve chamber 18 for closing the head valve 13.

However, due to the provision of the passage 15 and the start valve 14, such exhaust mechanism is complicated in construction. In addition, as the passage 15 is quite long, the nailing speed is adversely affected.

### SUMMARY OF THE INVENTION

An object of the present invention is to provide a pneumatic nailing machine which can improve the nailing speed and which may be adapted to be auto-controlled.

According to this invention, the pneumatic nailing machine includes a main housing extending along an axis, and having front and rear ends axially opposite to each other. The main housing defines a compressed air chamber disposed distal from the rear end to be supplied with primary pressured air, and a counter-pressure zone disposed proximate to the rear end. An inlet port is disposed upstream of the counter-pressure zone to be supplied with secondary pressured air. A striking cylinder is disposed in the main housing, and has a rear portion which defines an access opening for entry of the primary pressured air into the striking cylinder from the compressed air chamber. A piston and driver assembly is disposed in the striking cylinder and moved relative to the striking cylinder along the axis so as to drive a fastener out of the front end when the primary pressured air is supplied to the striking cylinder through the access opening. A head valve is disposed between the rear end of the main housing and the rear portion of the striking cylinder, and is movable relative to the striking cylinder between an opened position, where the primary pressured air is permitted to enter the striking cylinder through the access opening to generate an active pressure, and a closed position where the primary pressured air is prevented from entering the striking cylinder. The head valve has a front valve end and a rear valve end which is disposed downstream of the counter-pressure zone to be exerted upon by a counter pressure. Once the active pressure is made higher than the counter pressure, the front valve end is thrust open to displace the head valve from the closed position to the opened position.

An air valve unit is disposed between the counter-pressure zone and the inlet port, and is configured to be convertible between a let-through state, where the secondary pressured air is permitted to flow into the counter-pressure zone to exert the counter pressure on the rear valve end to counteract the active pressure of the primary pressured air so as to keep the head valve unmoved in the closed position, and a shut-off state, where, in response to a throttling action applied to the supply of the secondary pressured air, the flow of the secondary pressured air into the counter-pressure zone is disrupted, thereby rendering the counter pressure lower than the active pressure.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a sectional view of a conventional pneumatic nailing machine of U.S. Pat. No. 5,878,936;

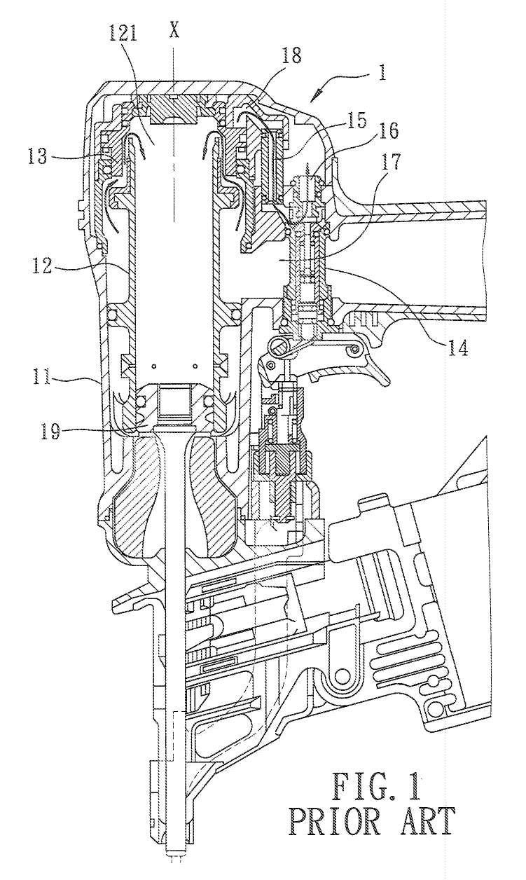

FIG. 2 is a partly sectioned schematic view of the preferred embodiment of a pneumatic nailing machine according to this invention;

FIG. 3 is a fragmentary sectional view of part of the preferred embodiment in a let-through state; and

FIG. 4 is a fragmentary sectional view of the preferred embodiment in a shut-off state.

### DETAILED DESCRIPTION OF THE PREFERRED EMBODIMENT

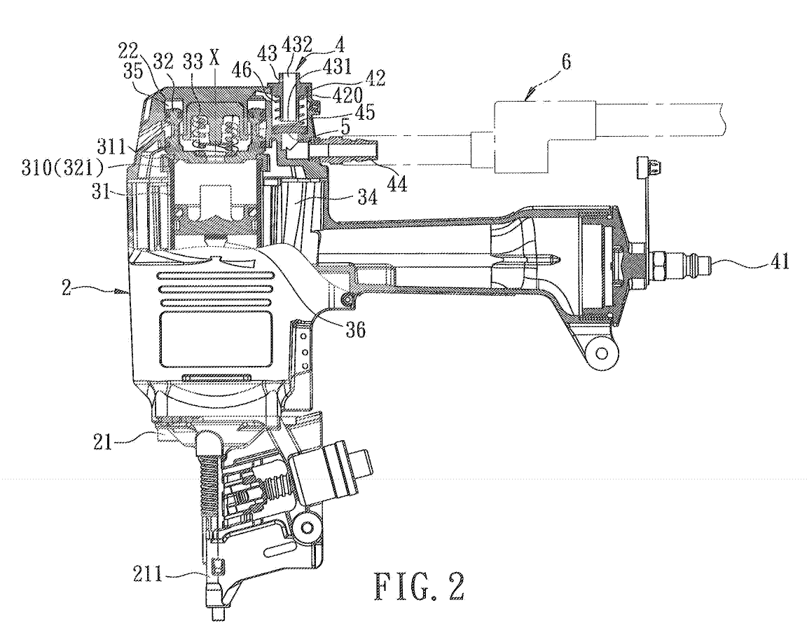

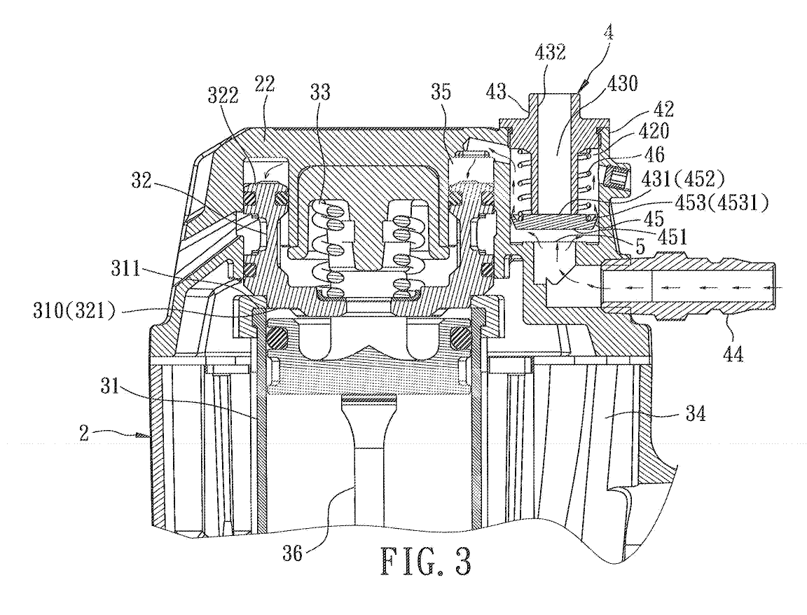

Referring to FIGS. 2 and 3, the preferred embodiment of a pneumatic nailing machine according to the present invention is shown to comprise a main housing 2 extending along an axis (X), and having a front end 21 which is provided with a nosepiece 211, and a rear end 22 opposite to the front end 21 in an axial direction. The main housing 2 defines a compressed air chamber 34 disposed distal from the rear end 22 to be supplied with primary pressured air through a coupler 41, and a counter-pressure zone 35 disposed proximate to the rear end 32. In addition, an inlet port 5 is disposed upstream of the counter-pressure zone 35, and is supplied with secondary pressured air through an adaptor 44 by means of a trigger unit 6. The trigger unit 6 may, for example, include a solenoid which is activated in response to actuation of the triggering unit or an electric signal to initiate a throttling action for supplying or interrupting supply the secondary pressured air through the inlet port 5.

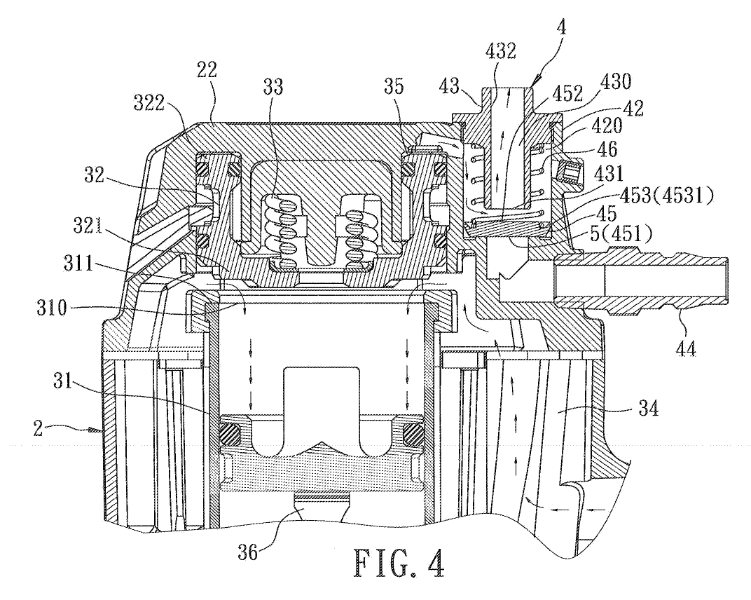

A striking cylinder 31 is disposed in the main housing 2, and has a rear portion 311 which is spaced apart from the rear end 22 of the main housing 2 in the axial direction to define an access opening 310 for entry of the primary pressured air into the striking cylinder 31 from the compressed air chamber 34. A piston and driver assembly 36 is disposed in the striking cylinder 31 and moved relative to the striking cylinder 31 along the axis (X) so as to drive a fastener (not shown) out of the nosepiece 211 when the primary pressured air is supplied to the striking cylinder through the access opening 310 (see FIG. 4).

A head valve 32 is disposed between the rear end 22 of the main housing 2 and the rear portion 311 of the striking cylinder 31, and is movable relative to the striking cylinder 31 between an opened position, where the primary pressured air is permitted to enter the striking cylinder 31 through the access opening 310 to generate an active pressure (P1), and a closed position where the primary pressured air is prevented from entering the striking cylinder. Specifically, the head valve 32 has a front valve end 321 and a rear valve end 322 which is disposed downstream of the counter-pressure zone 35 to be exerted upon by a counter pressure (P2). A biasing member 33 is disposed between the rear end 22 of the main housing 2 and the head valve 32 to bias the head valve 32 toward the closed position. Thus, once the active pressure (P1) is made higher than the counter pressure (P2), as shown in FIG. 4, the front valve end 321 of the head valve 32 is thrust open to displace the head valve 32 from the closed position to the opened position so as to permit the primary pressured air to burst into the striking cylinder 31, thereby driving the piston and drive assembly 36.

According to this invention, an air valve unit 4 is disposed between the counter-pressure zone 35 and the inlet port 5. Specifically, the air valve unit 4 includes a valve chamber 42 which defines an accommodation space 420 that extends axially to communicate the counter-pressure zone 35 with the inlet port 5, and an exhaust port 432 that is axially spaced apart from the inlet port 5 by the accommodation space 420. A tubular mount 43 extends axially from the exhaust port 432 and into the accommodation space 420 to terminate at an internal port 431 that is spaced apart from the inlet port 5, and which defines an air duct 430 that communicates the internal port 431 with the exhaust port 432. A valve disc 45 has front and rear disc surfaces 451, 452 axially opposite to each other. A flare check valve 453 extends rearwardly and divergently from a marginal region of said front disc surface 452 to terminate at a flared peripheral end 4531. The flared peripheral end 4531 is configured to be dragged on an inner tubular surface of the valve chamber 42 which defines the accommodation space 420. A biasing member 46 in the form of a coil spring 46 is sleeved on the tubular mount 43, and has front and rear anchoring ends that are secured respectively in the rear disc surface 452 of the valve disc 45 and the tubular mount 43 adjacent to the exhaust port 432 so as to bias the valve disc 45 toward the inlet port 5. In this embodiment the valve chamber 42 is integrally formed with the main housing 2, as shown in FIG. 3. Alternatively, the valve, chamber 42 may be configured to have the accommodation space 420 coupled with the counter-pressure zone 35 and the inlet port 5 by means of conduit members (not shown).

Referring to FIGS. 2 and 3, when the adaptor 44 is initially connected to a compressed air source, since the secondary pressured air upstream of the inlet port 5 is higher than the counter. pressure (P2) in the counter-pressure zone 35, the valve disc 45 is forced open by airflow of the secondary pressured air against the biasing action of the coil spring 46 toward a let-through state, the rear disc surface 452 of the valve disc 45 is engaged with the internal port 431 while the front disc surface 451 is removed from the inlet port 5. Hence, the flared peripheral end 4531 of the valve disc 45 is forced by the secondary pressured air to bend inwardly and radially so as to uni-directionally admit entry of the secondary pressured air into the counter-pressure zone 35 through the accommodation space 420, thereby exerting the counter pressure (P2) on the rear valve end 322 to counteract the active pressure (P1) of the primary pressured air for keeping the head valve 32 unmoved in the closed position. Meanwhile, communication between the air duct 430 and the accommodation space 420 is interrupted.

Referring to FIG. 4, when supply of the secondary pressured air is disrupted in response to the throttling action initiated by the solenoid of the trigger unit 6, the valve disc 45 is displaced by means of the biasing action of the coil spring 46 to a shut-off state, where the front disc 451 of the valve disc 45 closes the inlet port 5 while the rear disc surface 452 is disengaged from the internal port 431 to permit communication between the air duct 430 and the accommodation space 420 to resume. At this stage, the counter pressure (P2) is rendered lower than the active pressure (P1) so that the head valve 32 is forced open by the active pressure (P1) of the primary pressured air, while an exhaust route is established for exhausting the secondary pressured air in the counter-pressure zone 35 out of the exhaust port 432.

According to this invention, through control of the supply of the secondary pressured air by applying a throttling action to the adaptor 44, the air valve unit 4 is convertible between the let-through state and the shut-off state for performing a nail striking action. Such throttling action can be activated by virtue of the solenoid of the trigger unit 6. Therefore, the pneumatic nailing machine according to this embodiment may be adapted to perform an auto-striking action. Moreover, as the air valve unit 4 is provided close to the counter-pressure zone 35 and the valve disc 45 is controlled by an air pressure difference for automatically controlling the inlet port 5 and the internal port 431, the secondary pressured air can flow rapidly into and be exhausted swiftly from the counter-pressure zone 35, thereby improving the nailing speed. In addition, the construction of the air valve unit 4 is simplified and made compact.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

We claim:

1. A pneumatic nailing machine comprising:
a main housing extending along an axis, and having a front end and a rear end axially opposite to each other, said main housing defining
a compressed air chamber disposed distal from said rear end to be supplied with primary pressured air, and
a counter-pressure zone disposed proximate to said rear end;
an inlet port which is disposed upstream of said counter-pressure zone, and which is supplied with secondary pressured air;
a striking cylinder disposed in said main housing, and having a rear portion which defines an access opening for entry of the primary pressured air into said striking cylinder from said compressed air chamber;
a piston and driver assembly disposed in said striking cylinder and moved relative to said striking cylinder along the axis so as to drive a fastener out of said front end when the primary pressured air is supplied to said striking cylinder through said access opening;
a head valve disposed between said rear end of said main housing and said rear portion of said striking cylinder, and movable relative to said striking cylinder between an opened position, where the primary pressured air is permitted to enter said striking cylinder through said access opening to generate an active pressure, and a closed position, where the primary pressured air is prevented from entering said striking cylinder, said head valve having a front valve end and a rear valve end which is disposed downstream of said counter-pressure zone to be exerted upon by a counter pressure such that, once the active pressure is made higher than the counter pressure, said front valve end is thrust open to displace said head valve from the closed position to the opened position; and
an air valve unit interconnecting said counter-pressure zone and said inlet port, and configured to be convertible between a let-through state, where the secondary pressured air is permitted to flow into said counter-pressure zone to exert the counter pressure on said rear valve end to counteract the active pressure of the primary pressured air so as to keep said head valve unmoved in the closed position, and a shut-off state, where, in response to a throttling action applying to the supply of the secondary pressured air, the flow of the secondary pressured air into said counter-pressure zone is disrupted, thereby rendering the counter pressure lower than the active pressure.

2. The pneumatic nailing machine as claimed in claim 1, wherein said air valve unit includes
a valve chamber defining an accommodation space which is communicated with said counter-pressure zone, and which is downstream of said inlet port, and an exhaust port which is axially spaced apart from said inlet port by said accommodation space,
a tubular mount which extends axially from said exhaust port and into said accommodation space to terminate at an internal port that is spaced apart from said inlet port, and which defines an air duct that communicates said internal port with said exhaust port, and
a valve disc which is configured, such that, in the let-through state, said valve disc is engaged with said internal port while being removed from said inlet port, thereby interrupting communication between said air duct and said accommodation space, and such that, in the shut-off state, said valve disc closes. said inlet port while being disengaged from said internal port so as to permit, communication between. said air duct and said accommodation space to resume, thereby establishing an exhaust route for exhausting the secondary pressured air in said counter-pressure zone out of said exhaust port.

3. The pneumatic nailing machine as claimed in claim 2, wherein said air valve unit further includes a biasing member disposed to bias said valve disc toward said inlet port.

4. The pneumatic nailing machine as claimed in claim 3, wherein said biasing member is a coil spring which is sleeved on said tubular mount, and which has front and rear anchoring ends that are secured respectively in said valve disc and said tubular mount adjacent to said exhaust port.

5. The pneumatic nailing machine as claimed in claim 4, wherein said air valve unit has a flare check valve which is configured to extend rearwardly and divergently from said valve disc to terminate at a flared peripheral end, said flared peripheral end being dragged on an inner tubular surface of said valve chamber which defines said accommodation space, such that said flared peripheral end is forced by the secondary pressured air to bend inwardly and radially so as to uni-directionally admit entry of the secondary pressured air into said counter-pressure zone through said accommodation space when said air valve unit is in the let-through state.

6. The pneumatic nailing machine as claimed in claim 1, further comprising
a trigger unit disposed to initiate the throttling action.

7. The pneumatic nailing machine as claimed in claim 6, wherein said trigger unit includes a solenoid which is configured such that, in response to actuation of said triggering unit, said solenoid is activated to initiate the throttling action.
